(19) United States
(12) Patent Application Publication
(10) Pub. No.: US 2013/0136815 A1
(43) Pub. Date: May 30, 2013

(54) INSECT-REPELLENT OR INSECTICIDAL COMPOSITION COMPRISING EXTRACT OR FRACTION OF OAK VINEGAR AS AN EFFECTIVE INGREDIENT FOR CONSERVATION OF CULTURAL HERITAGE

(71) Applicants: Mi Hwa Jung, Daejeon (KR); Jin Young Hong, Daejeon (KR); Chang Wook Jo, Daejeon (KR); Young-Hee Kim, Daejeon (KR); Jung Eun Choi, Daejeon (KR); So Young Jeong, Daejeon (KR); Soon Hyoung Ghang, Seoul (KR)

(72) Inventors: Mi Hwa Jung, Daejeon (KR); Jin Young Hong, Daejeon (KR); Chang Wook Jo, Daejeon (KR); Young-Hee Kim, Daejeon (KR); Jung Eun Choi, Daejeon (KR); So Young Jeong, Daejeon (KR); Soon Hyoung Ghang, Seoul (KR)

(73) Assignee: Republic of Korea (National Research Institute of Cultural Heritage), Daejeon (KR)

(21) Appl. No.: 13/813,905

(22) PCT Filed: Sep. 10, 2010
(86) PCT No.: PCT/KR2010/006157

§ 371 Date: Feb. 1, 2013

(30) Foreign Application Priority Data
Aug. 2, 2010 (KR) 10-2010-0074795

(51) Int. Cl. A01N 65/08

(52) U.S. Cl. CPC A01N 65/08
USPC 424/771

(57) ABSTRACT

An insect-repellent or insecticidal composition comprising an extract or an organic solvent fraction of oak vinegar as an effective ingredient, is provided. The composition comprising extract or organic solvent fraction of oak vinegar as an effective ingredient has superior insect-repellent or insecticidal activities against lasioderma serricorne, which damages tobacco, grains, paper or clothes, reticulitermes speratus kyushuensis Morimoto, which chews the woods from within, or sitophilus oryzae, which has strong tolerance to insecticides, and therefore, can be applied efficaciously as an insect-repellent or insecticidal composition to conserve wooden furniture, an old house, or many organic cultural heritages.

### TECHNICAL FIELD

The present invention relates to an insect-repellent or insecticidal composition having an extract or fraction of oak vinegar as an effective ingredient for conservation of cultural heritage.

### BACKGROUND ART

Organic cultural heritages among the designated ones account for 28.5% of national treasure and 44.1% of treasure in Korea, and preservation followed by biological damages due to insects or microorganisms is needed. In comparison with mineral cultural heritages composed of metal, stone, pottery, or earthenware, the organic cultural heritages are composed of fabric, paper, or wood and are intrinsically apt to be harmed by microorganisms and insects. These damages to the organic cultural heritages are very serious problems, since these not only sully aesthetic value of the cultural heritages by contaminating the appearance or damaging the prints or patterns, but also damaging the structure by destroying the constituting material.

Wood-decay fungus is a serious attacker to wooden cultural heritage, reducing aesthetic and structural values. The fungus that causes wood decay includes white fungus, brown fungus, and surface mould, showing diverse wood decay conditions such as, dryness in wooden tissues, decay, cracks, sponge-like structure, fuzzy or powdery surface growths, or discoloration.

Lasioderma serricorne, commonly known as the tobacco beetle, is a main storage insect pest that appears twice or three times a year and harms tobacco, grains, paper, clothes, and wood. Also, these insects inhabit wood cultural heritage and organic movable cultural heritages, seriously damaging their structure. According to a recent research by the National Research Institute of Cultural Heritage (NRICH) into the major wooden cultural heritage damages caused by organisms, examples of the major wooden cultural heritage damage caused by termites and lasioderma serricorne were revealed and the efforts are being made to prevent damages from these insects.

The white ants (reticulitermes speratus) are a group of eusocial insects classified from a queen ant, which inhabit one place over 3 decades. The white ants are representative insects that are detrimental to humans or human concerns. The pharaoh ant (monomrium pharaonis), largely inhabiting in a house, is also a main culprit for food contamination, and particularly a serious concern for houses with small children. According to an interim report conducted by forest researchers from 1997 to 2006 on a research into the forest business, 33 places out of 69 wooden cultural heritages, including Guk-Rak-Bo-Jeon at the Muwi temple in Gangjin, southern district of Jeolla (No. 13 of National Treasure), Dae-Woong-Jeon at the Beopju temple in Boeun, northern district of Chunchungdo (No. 915 of Treasure), and Guk-Rak-Jeon at the Silsang temple in Suncheon, southern district of Jeolla (tangible cultural asset), were damaged by the termites.

Meanwhile, rutacese and limonoids of meliaceae are the natural substances that have been reported of providing anti-feeding effect towards the ants (Serit M. et al., Journal of chemical ecology, 1992, 18(4); 593-603). The neem oil from azadirachta indica was also reported of its anti-feeding effect (Ishida M. et. al., Bioscience Biotechnology and Biochemistry, 1992, 56(11); 1835-1838).

The rice weevils (sitophilus oryzae(L.)), strongly resistant to pesticide, is cosmopolitan, and damages not only the quantity, but also the quality of the stored crops in combination with changes in temperature and humidity of the environment where the crops are stored. The rice weevil particularly threatens food safety, as this induces rapid growth of fungi, thereby causing crops to decay and mycotoxin to be produced.

Controlling the rice weevil is important to save the stored crops, and it is particularly important in the food sanitation area to prevent or control decay or production of toxics by fungi (Tae-Joong Y U N, et. al., Korean J. appl. Entomol., 2003, 42(4); 329-334).

Gas fumigation is the most widely used to exterminate pests and insects inhabiting in cultural heritage. Now, insecticidal fumigation gas such as methyl bromide or sulfuryl fluoride, sterilizing fumigation gas such as ethylene oxide or propylene oxide, insecticidal-sterilizing fumigation gas such as the mixture of methyl bromide and ethylene oxide, and sublimable insecticidal-sterilizing p-formaldehyde such as p-dichlorobenzene, dichlovos, camphor, clover oil, and sublimable sterilizing or mycostats such as thymol are used as the sterilizer.

Among these, the mixed gas of ethylene oxide and methyl bromide as insecticide, is widely used to prevent germs and insects which harm the cultural heritages.

The gas fumigations are stable and show rapid effects, but do not last long, so additional preservative treatment is required especially in wooden structures. Methyl bromide, the widely used toxic chemical which is colorless and odorless, is regulated under environmental concerns, since this is 50 times destructive to ozone layer than chlorofluorocarbon (CFC). For now, methyl bromide is rarely used in many developed countries, expect for a few cases, such as use in quarantines.

Due to the problems of using chemicals in preserving organic cultural heritage, such as discoloration, peeling-off of pigment and dye, and adverse health effects, demands for the preservatives based on natural substances are increasing.

The natural substances reported of having insect-repellent or insecticidal activities so far are as follows.

According to the research on antibiotic effects of the extracts of medicinal plants, tangerine peel, forsythia fruit, lappa fruit, gentiana macrophylla Pallas, picrorrhizae rhizoma, siegesbockia herb, Nelumbo nucifera Gaertner, rosa laevigata, caesalpinia sappan L., or nutmeg are reported to provide distinctive inhibition effects on microorganism, and garlic extract, onion extract, chili pepper extract, white radish extract are reported to inhibit the growth of escherichia coli, salmonella thyposa, shigella dysentriae, or staphylococcus aureus.

In Japan, experiment on the antibacterial activity against pathogenic fungi of cryptomeria japonica extract was conducted. In France, phenolic extract from heartwood of European oak was researched for its repelling activity against white rot fungus, and recently, substance extracted from the heart wood of eperua was applied to white rot fungus to experiment the activity of the extract. In U.S, repelling effect of solvent extract of eperua heartwood against the brown-rot fungi and the insects was confirmed. Additionally, hinokitiol, an extract of Taiwanese chamaecyparis obtuse, was discovered to have strong antibacterial effect on not only dust fungus such as yeast fungus, but also basidiomycetes, the wood-rotting fungi.

There are numerous studies conducted regarding new insecticides that utilize the secondary metabolites of the plants. One of these studies for natural substance-based insecticides confirmed that, physostigmine, which is the poisonous substance isolated from the African leguminous plant, i.e., physostgima venenosum seed, inhibits particularly acetylcholinesterase, and another study reported that pyrethrin, which is insecticidal substance contained in the seed cases of perennial plant pyrethrum, affects membrane permeability of K⁺ and Na⁺ ion in nervous system of insects, intervening normal nerve stimulation, and thus killing the insects.

Korean Patent Publication No. 2002-0063375 discloses biocide composition comprising volatile extracts of natural medicines including eugenia caryophyllata thunberg, boswellia carterii birdwood and star anise, as effective components for conservation of cultural properties, and method for conserving cultural properties using the same. Korean Patent Publication No. 2002-0087568 discloses insecticidal composition containing extract from plants including acorus gramineus, acorus calamus var. angustatus, cinnamomum camphora, agastache rugosa, cinnamomum sieboldii, cinnamomum cassia, kaempferia galangal, illicium vernum, angelica dahurica, cnidium officinale, piper nigrum, zanthoxylum coreanum, zanthoxylum piperitum, zanthoxylum schinifolium, eugenia carrophillata, nardostachys chinensis, tiliaamurensis, lysimachia davurica, aquillaria agallocha, agastacherugosa, must and oil, brassica juncea, horseradish oil, cocholeria aroracia, and insecticidal chemical compound extracted from the said plants.

However, so far, extract or fraction of oak vinegar having insect-repellent or insecticidal activities has not been reported yet.

Therefore, the inventors of the present invention have studied the extracted bioactive substances from a wide range of natural sources in pursuit of the substance which can provide strong insect-resistant properties and insecticidal activities, and confirmed the excellent insect-repellent and insecticidal properties of the extract or fraction of oak vinegar and thus completed the present invention.

### DISCLOSURE OF INVENTION

### Technical Problem

It is an object of the present invention to provide an insect-repellent or insecticidal composition comprising an extract from oak vinegar as an effective ingredient.

It is another object of the present invention to provide an insect-repellent or insecticidal composition comprising organic solvent of a fraction of oak vinegar as an effective ingredient.

It is yet another object of the present invention to provide a conservation method of cultural heritage using said compositions.

### Solution to Problem

In order to accomplish one of said objects, an insect-repellent or insecticidal composition comprising an extract from oak vinegar as an effective ingredient, is provided.

Furthermore, a composition comprising organic solvent of an insect-repellent or insecticidal fraction of oak vinegar as an effective ingredient, is provided.

Furthermore, a conservation method of cultural heritage using said compositions, is provided.

### Advantageous Effects of Invention

An extract of oak vinegar or fraction of the organic solvent therefrom according to the present invention provides insecticidal or insect-repellent activities against tobacco beetlethat damage tobacco, cereals, papers, clothes or woods, white antwhich nibbles away the inside of trees, and rice weevilwhich harms the crops and has strong tolerance against insecticides, and thus is applicable efficacaciously as insecticidal or insect-repellent compositions to conserve many organic cultural heritage made of wood including furniture or old house.

### BRIEF DESCRIPTION OF DRAWINGS

FIG. 1 is a graphical indication of the average mortality number of lasioderma serricorne by the addition of an extract or fraction of oak vinegar according to an embodiment of the present invention;

FIG. 2 is a graphical indication of the average mortality number of lasioderma serricorne by the addition of methylene chloride (MC) fraction of oak vinegar according to an embodiment of the present invention;

FIG. 3 is a graphical indication of the average mortality number of lasioderma serricorne by the addition of ethyl acetate (EtOAc) fraction of oak vinegar according to an embodiment of the present invention;

FIG. 4 is a graphical indication of the average mortality number of reticulitermes speratus kyushuensis Morimoto by the addition of methylene chloride (MC) fraction or ethyl acetate (EtOAc) fraction of oak vinegar according to an embodiment of the present invention;

FIG. 5 is a graphical indication of inhibition effect of feeding of reticulitermes speratus kyushuensis Morimoto by the addition of methylene chloride (MC) fraction or ethyl acetate (EtOAc) fraction of oak vinegar according to an embodiment of the present invention; and

FIG. 6 is a graphical indication of the average mortality number of sitophilus oryzae by the addition of an extract or fraction of oak vinegar according to an embodiment of the present invention.

### BEST MODE FOR CARRYING OUT THE INVENTION

The present invention will be explained in greater detail below.

The present invention provides an insect-repellent or insecticidal composition comprising an extract of oak vinegar as an effective ingredient.

The vinegar extract may be prepared or purchased, but the manner of obtaining the extract is not strictly limited.

The extract of oak vinegar may be obtained by vacuum concentrating oak vinegar with rotary vacuum evaporator (EYELA, Japan).

The extract may be obtained at 18˜32° C. in vacuum concentration, and preferably at 20˜27° C., although the temperature is not strictly limited.

Furthermore, the present invention provides an insect-repellent or insecticidal composition comprising an organic solvent fraction of oak vinegar as an effective ingredient.

The organic solvent fraction of the oak vinegar may desirably be methylene chloride (MC) fraction, ethyl acetate (EtOAc) fraction, or butanol (BuOH) fraction.

The preparation method of an organic solvent fraction of oak vinegar may include steps of:

(S1) obtaining an extract of oak vinegar;

(S2) obtaining methylene chloride (MC) fraction by mixing the oak vinegar of (S1) with water and methylene chloride (MC) and separating the mixture into a water layer and an organic layer using separating funnel;

(S3) obtaining ethyl acetate (EtOAc) fraction by mixing the separated water layer of (S2) with ethyl acetate (EtOAc) fraction and separating the mixture into a water layer and an organic layer; and

(S4) obtaining water fraction and butanol (BuOH) fraction by mixing the separated water layer of (S3) with butanol (BuOH) and separating the mixture into a water layer and an organic layer using a separating funnel.

The extract of (S1) may be prepared or purchased, but the manner of obtaining the extract is not strictly limited.

The mortality number of lasioderma serricorne and sitophilus oryzae was measured to measure the insecticidal activities of oak vinegar of the embodiment. As time had passed, 15˜25 out of 30 lasioderma serricorne were killed, and 11˜24 out of 30 sitophilus oryzae were killed. Therefore, it was confirmed that the oak vinegar extract of the embodiment had insecticdal activities (see Table 1 and 6).

The mortality number of lasioderma serricorne was measured to measure the insecticidal activities of organic solvent fraction of oak vinegar extract of the embodiment. 20˜30 out of 30 lasioderma serricorne were killed by the injection of methylene chloride (MC) fraction, and 17˜28 killed by the injection of ethyl acetate (EtOAc) fraction.

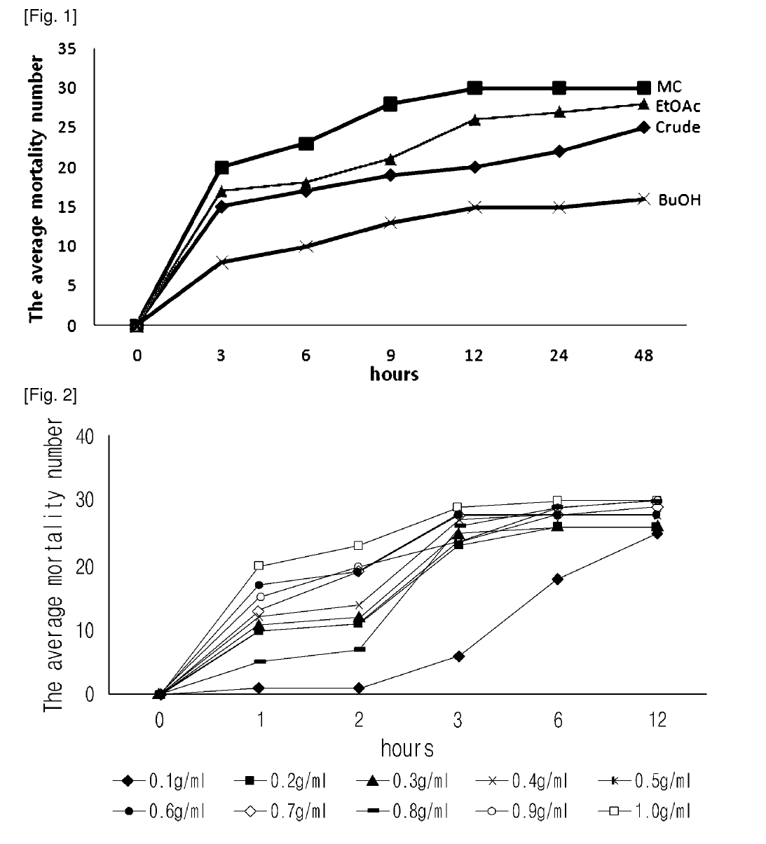

The mortality number of lasioderma serricorne was high when methylene chloride (MC) fraction was injected, and thus it was confirmed that methylene chloride (MC) fraction had the most excellent insecticidal activities (see Table 1 and FIG. 1).

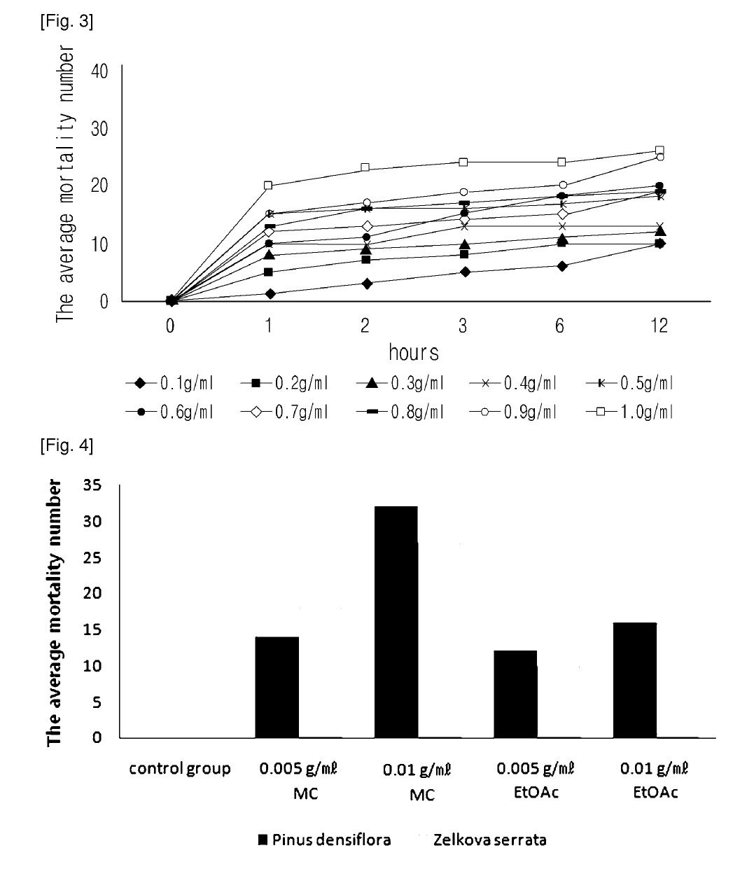

It was also confirmed that insecticidal activities of the methylene chloride (MC) fraction and ethyl acetate (EtOAc) fraction were concentration and time-dependent (see Tables 2 and 3 and FIGS. 2 and 3).

The morality number of reticulitermes speratus kyushuensis Morimoto was measured to measure the insecticidal activities of organic solvent fraction of oak vinegar fraction of the embodiment. 32 out of 100 reticulitermes speratus kyushuensis Morimoto were killed by the injection of methylene chloride (MC) fraction into pine tree specimen, and 27 out of 100 reticulitermes speratus kyushuensis Morimoto were killed by the injection of methylene chloride (MC) fraction into zelkova tree specimen, respectively. Additionally, 16 out of 100 reticulitermes speratus kyushuensis Morimoto were killed by the injection of ethyl acetate (EtOAc) fraction into pine tree specimen, and 18 out of 100 reticulitermes speratus kyushuensis Morimoto were killed by the injection of ethyl acetate (EtOAc) fraction into zelkova tree specimen respectively (see Table 4 and FIG. 4).

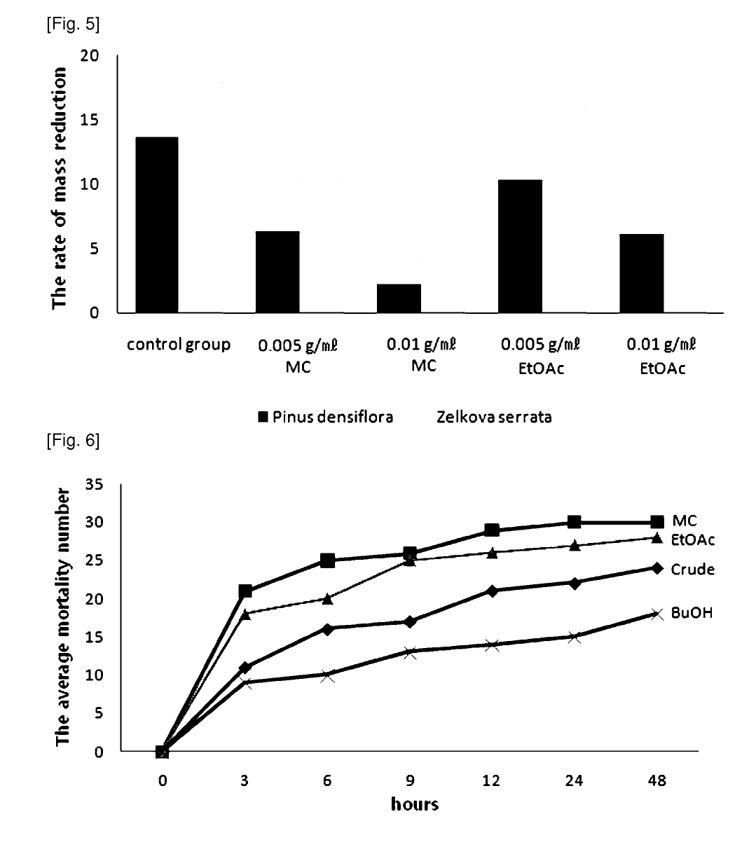

The rate of mass reduction of wood specimen was measured to measure antifeeding activities towards reticulitermes speratus kyushuensis Morimoto by organic solvent fraction of oak vinegar according to the embodiment of the present invention. The mass of wood specimen was decreased by 2.24% and 4.38%, respectively, by the injection of methylene chloride (MC) fraction into pine tree and zelkora tree respectively, and by 6.07% and 9.58%, respectively, by the injection of ethyl acetate (EtOAc) fraction into pine tree specimen and xelkova tree specimen, respectively. In control group, the rate of mass reduction of pine tree specimen (13.67%) is lower than that of zelkova tree specimen (18.01%). Methylene chloride (MC) fraction and ethyl acetate (EtOAc) fraction showed the most excellent antifeeding acitivities towards reticulitermes speratus kyushuensis Morimoto. (see Table 5 and FIG. 5).

When methylene chloride (MC) fraction was injected into pine tree specimen, 32 reticulitermes speratus kyushuensis Morimoto were killed and the mass of wood specimen was decreased by 2.24%. When methylene chloride (MC) fraction was injected into zelkova tree, 27 reticulitermes speratus kyushuensis Morimoto were killed and the mass of wood specimen was decreased by 4.38%. The methylene chloride (MC) fraction showed the most excellent insecticidal activities and antifeeding activities towards reticulitermes speratus kyushuensis Morimoto. (see Tables 4 and 5 and FIGS. 4 and 5).

The mortality number of reticulitermes speratus kyushuensis Morimoto was measured to measure the insecticidal activities of organic solvent fraction of oak vinegar extract. 21 out of 30 reticulitermes speratus kyushuensis Morimoto were killed by the treatment with methylene chloride (MC) fraction, and 18 were killed by the treatment with ethyl acetate (EtOAc) fraction.

The methylene chloride (MC) fraction showed the highest mortality number of reticulitermes speratus kyushuensis Morimoto and it was thus confirmed that the methylene chloride (MC) fraction had the most excellent insecticidal activities (see Table 6 and FIG. 6).

The oak vinegar fraction of the embodiment has the superior insecticidal activities towards lasioderma serricorne, reticulitermes speratus kyushuensis Morimoto, and sitophilus oryzae, and thus can be used efficaciously as the insect-repellent or insecticidal composition for cultural heritage conservation.

The present invention also provides a conservation method of cultural heritage.

The composition according to the present invention may include, as an effective ingredient, methylene chloride (MC) fraction, ethyl acetate (EtOAc) fraction, or butanol (BuOH) fraction, and preferably the methylene chloride (MC) fraction.

In one embodiment, the cultural heritage may be an organic cultural heritage, which may include wood, paper or textile, and preferably the wood cultural heritage. The composition with insect-repellent or insecticidal activities may include the pure volatible extract or the extract diluted in a predetermined concentration. The composition with insect-repellent or insecticidal activities may be applied to cultural heritages by direct spraying, coating, fumigation, air freshing, or wrapping with a wrapping paper on which a composition with insect-repellent or insecticidal activities is coated, but the method is not strictly limited thereto. The composition with insect-repellent or insecticidal activities may be in an aerosol phase for direct spraying, tincture or liquid phase for fumigation or air freshing, or gel matrix for sustained-release, but the phase of the composition is not strictly limited thereto.

The amount of composition with insect-repellent or insecticidal activities applied to the cultural heritage may differ depending on the components or applying method. By way of example, the concentration of the composition for application by air freshing, may be regulated to 50 ml/m³ or above, and preferably to 125 ml/m³ or above.

### MODE FOR THE INVENTION

The present inventive technical concept will be explained in greater detail below based on the exemplary embodiments which are not to be construed as limiting the present inventive concept.

### EXAMPLE 1

### Preparation of Oak Vinegar Extract

Su-chon-im-san Co., Ltd. carbonized the oak trees at 400° C. and obtained oak vinegar by distillation, and the oak vinegar was purchased from Su-chon-im-san Co., Ltd.

20 l of the distilled oak vinegar was vacuum concentrated at 25° C. using rotary vacuum evaporator (EYELA, Japan), and 68.64 g of extract of oak vinegar was obtained.

### EXAMPLE 2

### Preparation of Oak Vinegar Fraction

68.94 g of oak vinegar extract of Example 1 was mixed with of 1 l of water and 1 l of methylene chloride (MC), and filtered through a separatory funnel to be divided into a water layer and an organic layer. Accordingly, methylene chloride (MC) fraction was obtained from the organic layer. The water fraction was mixed with 1 l of ethyl acetate (EtOAc) and filtered through a separatory funnel to be divided into a water layer and an organic layer. Accordingly, ethyl acetate (EtOAc) fraction was obtained from the organic layer. The water fraction was mixed with 1 l of butanol (BuOH) and filtered through a separatory funnel to be divided into a water layer and an organic layer, and butanol (BuOH) fraction was obtained from the organic layer.

Accordingly, methylene chloride (MC) fraction (40.10 g), ethyl acetate (EtOAc) fraction (6.64 g), butanol (BuOH) fraction (1.88 g) and water fraction (4.95 g) were obtained.

### EXAMPLE 3

### Preparation of Composition Comprising Extract or Fraction of Oak Vinegar as an Effective Ingredient

The extract or fraction of oak vinegar prepared by Example 1 or 2 was melt in ethanol in the concentration of 0.005, 0.01, 0.1, 0.2, 0.3, 0.4, 0.5, 0.6, 0.7, 0.8, 0.9 and 1.0 g/ml respectively, to prepare composition comprising extract or fraction of oak vinegar as an effective ingredient.

### Experimental Example

### Measurement of Insecticidal Activities of Extract or Fraction of Oak Vinegar

<1-1> Rearing of Test Insects to Measure Insecticidal Activities of Extract or Fraction of Oak Vinegar

Lasioderma serricorne and R. speratus kyushuensis morimoto and sitophilus oryzae were used to measure insecticidal activities of extract or fraction of oak vinegar.

The test insects were provided from KT&G company and cultured. Lasioderma serricorne was cultured on the culture medium which was prepared by mixing the whole-wheat flour and yeast were mixed by the ratio of 95:5 in a thermohydrostat at 28° C. under 70%, and fermenting the mixture at room temperature for three days. R. speratus kyushuensis morimoto and sitophilus oryzae were cultured at room temperature.

<2-1> Measurement of Insect-Repellent or Insecticidal Activities of Oak Vinegar Extract Against Lasioderma Serricorne

Topical application was used to measure insecticidal activities of extract or fraction of oak vinegar against lasioderma serricorne.

30 lasioderma serricorne adults were divided into 5 groups. Oak vinegar extract, methylene chloride (MC) fraction, ethyl acetate (EtOAc) fraction and butanol (BuOH) fraction were mixed with ethanol in concentration of 0.7 g/ml, respectively, and 1 μl of the resultant mixtures were injected into the abdomens of the lasioderma serricorne adults. 100% of ethanol was used in a control group. The lasioderma serricorne adults were then cultured in a thermohydrostat controlled day and night at 28° C., under 70% for 72 hours and the mortality number of the test insects were measured 5 times with eyes and through a stereomicroscope (stemi-2000 C, Xeiss), and the average mortality numbers were obtained. The death of the test insects was confirmed after irradiating light temporarily to the test insects and stimulating with a sharp stick the abdomens of the lasioderma serricorne adults and counting the number of unmoving insects. 100% of ethanol was used in a control group. The result was listed in Table 1 and FIG. 1.

TABLE 1

| | The average mortality number of lasioderma serricorne | | | | | |
|---|---|---|---|---|---|---|
| hour | 3 | 6 | 9 | 12 | 24 | 48 |
| Oak vinegar | 15 | 17 | 19 | 02 | 22 | 25 |
| extract(Crude) | | | | | | |
| MC | 20 | 23 | 28 | 30 | 30 | 30 |
| EtOAc | 17 | 18 | 21 | 26 | 27 | 28 |
| BuOH | 8 | 10 | 13 | 15 | 15 | 16 |
| control | 0 | 0 | 0 | 0 | 0 | 0 |
| group(Ethanol) | | | | | | |

According to Table 1 and FIG. 1, after 3 hours, 20 out of 30 lasioderma serricorne were killed by the addition of methylene chloride (MC) fraction, 17 by the addition of ethyl acetate (EtOAc) fraction, and 8 by the addition of butanol (BuOH) fraction. After 48 hours, a majority of lasioderma serricorne, that is, 25˜30 out of 30 were killed by the addition of oak vinegar extract, methylene chloride (MC) fraction and ethyl acetate (EtOAc) fraction.

Accordingly, it was confirmed that the extract or fraction of oak vinegar showed superior insect-repellent or insecticidal activities against lasioderma serricorne.

<2-2> Measurement of Insecticidal Activities of Methylene Chloride (MC) Fraction of Oak Vinegar According to Concentrations

The concentration-dependency of methylene chloride (MC) fraction of <2-1>, which showed the active insecticidal effect, was measured regarding insecticidal activities thereof. The same test method as that of <2-1> was applied, except the fact that culturing was done for 12 hours after the injection of the methylene chloride (MC) fraction of oak vinegar of Example 3. The result is listed in Table 2 and FIG. 2.

TABLE 2

The average mortality number
of lasioderma serricorne
hour

| | | | | | |
|---|---|---|---|---|---|
| concentration | 1 | 2 | 3 | 6 | 12 |

| | | | | | | |
|---|---|---|---|---|---|---|
| MC | 0.1 g/ml | 1 | 1 | 6 | 18 | 25 |
| fraction | 0.2 g/ml | 10 | 11 | 23 | 26 | 26 |
| | 0.3 g/ml | 11 | 12 | 25 | 26 | 26 |
| | 0.4 g/ml | 12 | 14 | 27 | 28 | 29 |
| | 0.5 g/ml | 10 | 11 | 24 | 28 | 28 |
| | 0.6 g/ml | 17 | 19 | 28 | 28 | 28 |
| | 0.7 g/ml | 13 | 19 | 28 | 28 | 29 |
| | 0.8 g/ml | 5 | 7 | 26 | 29 | 30 |
| | 0.9 g/ml | 15 | 20 | 24 | 29 | 30 |
| | 1.0 g/ml | 20 | 23 | 29 | 30 | 30 |
| | Ethanol(con- | 0 | 0 | 0 | 0 | 0 |
| | trol group) | | | | | |

According to Table 2 and FIG. 2, after 3 hours of injecting methylene chloride (MC) fraction, the mortality number of lasioderma serricorne was 6 at concentration of 0.1 g/ml, but 29 at concentration of 1.0 g/ml, thus proving that insecticidal effect is more active at a higher concentration. After 12 hours, a majority of lasioderma serricorne, that is, 25˜30 were killed.

Accordingly, methylene chloride (MC) fraction of oak vinegar showed superior insecticidal activities towards lasioderma serricorne.

<2-3> Measurement of Insecticidal Activities of Ethyl Acetate (EtOAc) Fraction of Oak Vinegar According to Concentrations

The concentration-dependency of ethyl acetate(EtOAc) fraction of <2-1>, which showed the active insecticidal effect, was measured regarding insecticidal activities thereof. The same test method as that of <2-1> was applied, except the fact that culturing was done for 12 hours after the injection of ethyl acetate (EtOAc) fraction of oak vinegar of Example 3. The result is listed in Table 3 and FIG. 3.

TABLE 3

| | | The average mortality number | | | | |
|---|---|---|---|---|---|---|
| | | of lasioderma serricorne | | | | |
| | | hour | | | | |
| concentration | | 1 | 2 | 3 | 6 | 12 |
| EtOAcfraction | 0.1 g/ml | 1 | 3 | 5 | 6 | 10 |
| | 0.2 g/ml | 5 | 7 | 8 | 10 | 10 |
| | 0.3 g/ml | 8 | 9 | 10 | 11 | 12 |
| | 0.4 g/ml | 10 | 10 | 13 | 13 | 13 |
| | 0.5 g/ml | 15 | 16 | 16 | 17 | 18 |
| | 0.6 g/ml | 10 | 11 | 15 | 18 | 20 |
| | 0.7 g/ml | 12 | 13 | 14 | 15 | 19 |
| | 0.8 g/ml | 13 | 16 | 17 | 18 | 19 |
| | 0.9 g/ml | 15 | 17 | 19 | 20 | 25 |
| | 1.0 g/ml | 20 | 23 | 21 | 24 | 26 |
| | Ethanol(con- | 0 | 0 | 0 | 0 | 0 |
| | trol group) | | | | | |

According to Table 3 and FIG. 3, after 3 hours of injecting ethyl acetate (EtOAc) fraction, the mortality number of lasioderma serricorne was 5 at concentration of 0.1 g/ml, but 24 at concentration of 1.0 g/ml, thereby proving that superior insecticidal activities are provided at a higher concentration. After 12 hours, a majority of lasioderma serricorne, that is, 25˜26 insects were killed at concentration of 0.9˜1.0 g/ml.

Accordingly, methylene ethyl acetate (EtOAc) fraction of oak vinegar showed superior insecticidal activities towards lasioderma serricorne.

Accordingly, the composition comprising extract or fraction of oak vinegar as an effective ingredient has superior insect-repellent or insecticidal activities against lasioderma serricorne, which damages tobacco, grains, paper or clothes, or against sitophilus oryzae, which has strong tolerance to insecticides, and therefore, can be applied efficaciously as an insect-repellent or insecticidal composition to conserve wooden furniture, an old house, or many organic cultural heritages.

<3-1> Measurement of Insecticidal Activities of Methylene Chloride (MC) Fraction or Ethyl Acetate (EtOAc) Fraction of Oak Vinegar Towards Reticulitermes Speratus Kyushuensis Morimoto

The insecticidal activities of oak vinegar fraction against reticulitermes speratus kyushuensis Morimoto was measured.

The insecticidal or inset-repellent actvities of methylene chloride (MC) fraction, and ethyl acetate (EtOAc) fraction of oak vinegar against reticulitermes speratus kyushuensis Morimoto was measured by treating the specimen of pine tree or zelkova tree with methylene chloride (MC) fraction, and ethyl acetate (EtOAc) fraction, and measuring, after 3 weeks, the mortality number of 100 reticulitermes speratus kyushuensis Morimoto for 5 times to obtain the average mortality number. The result is listed in Table 4 and FIG. 4.

TABLE 4

| | | | The averate mortality number | |
|---|---|---|---|---|
| | | | of reticulitermes speratus | |
| | | | kyushuensis Morimoto | |
| | concentration | | pine treezelkova tree | |
| MC fraction | 0.005 | g/ml | 14 | 18 |
| | 0.01 | g/ml | 32 | 27 |
| EtOAc fraction | 0.005 | g/ml | 12 | 10 |
| | 0.01 | g/ml | 16 | 18 |

| | | |
|---|---|---|
| Ethanol | 0 | 0 |
| (control group) | | |

According to Table 4 and FIG. 4, when methylene chloride (MC) fraction and ethyl acetate (EtOAc) fraction were injectedat concentration of 0.005 g/mel, as the average mortality number of reticulitermes speratus kyushuensis Morimoto, 14 and 12 were killed in the pine tree specimen, respectively, and 18 and 10 were killed in the zelkova tree specimen, respectively. Compared to above, by the injection of methylene chloride (MC) fraction and ethyl acetate (EtOAc) fraction at concentration of 0.01 g/ml, 32 and 16 were killed in the pine tree specimen, respectively, and 27 and 18 were killed in the zelkova tree specimen, respectively, thereby proving that the mortality number increased when the fraction was included with the higher concentration.

Accordingly, it was confirmed that the methylene chloride (MC) fraction and the ethyl acetate (EtOAc) fraction of oak vinegar provided superior insecticidal activities against reticulitermes speratus kyushuensis Morimoto.

<3-2> Measurement of Insect-Repellent Activities of Methylene Chloride (MC) Fraction or Ethyl Acetate (EtOAc) Fraction of Oak Vinegar to Reticulitermes Speratus Kyushuensis Morimoto

The insect-repellent activities of the fraction of oak vinegar against reticulitermes speratus kyushuensis Morimoto was measured.

The insect-repellent or insecticidal compositions comprising of methylene chloride (MC) fraction and ethyl acetate (EtOAc) fraction were injected into pine tree speicmen and zelkova tree speicmen. After 3 weeks, according to the experiment method of Korea Forest Research Institute (KFRI), the rate of mass reduction of 100 reticulitermes speratus kyushuensis Morimoto of the pine tree or zelkova tree specimen according to the feeding of the insects was measured. The result is listed in Table 5 and FIG. 5.

TABLE 5

| | | | Rate of mass reduction | |
|---|---|---|---|---|
| | | | of tree specimen(%) | |
| | concentration | | pine tree | zelcova tree |
| MC fraction | 0.005 | g/ml | 6.36 | 10.22 |
| | 0.01 | g/ml | 2.24 | 4.38 |
| EtOAc fraction | 0.005 | g/ml | 10.31 | 15.91 |
| | 0.01 | g/ml | 6.07 | 9.58 |

| | | |
|---|---|---|
| Ethanol | 13.67 | 18.01 |
| (control group) | | |

According to Table 5 and FIG. 5, by the injection of methylene chloride (MC) fraction and ethyl acetate (EtOAc) fraction of the oak vinegar, the rate of mass reduction of the pine tree specimen was 2.24˜10.31% compared to 13.67% of the control group, and the rate of mass reduction of the zelkova tree specimen was 4.38˜15.91% compared to 18.01% of the control group. Since the mass reduction of the tree specimens was associated with the feeding of the reticulitennes speratus kyushuensis Morimoto, this reveals decrease of feeding by the reticulitermes speratus kyushuensis Morimoto.

Accordingly, it was noted that the ethylene chloride (MC) fraction and ethyl acetate (EtOAc) fraction of the oak vinegar inhibits feeding of reticulitermes speratus kyushuensis Morimoto.

Accordingly, the composition comprising an organic solvent fraction oak vinegar as an effective ingredient has superior insect-repellent or insecticidal activities against reticulitennes speratus kyushuensis Morimoto, which chews the woods from within, and therefore, can be applied efficaciously as an insect-repellent or insecticidal composition to conserve wooden furniture, an old house, or many organic cultural heritages.

<4-1> Measurement of Insecticidal Activity of an Extract and Fraction of an Oak Vinegar Against Sitophilus Oryzae

400 μl of the composition comprising oak vinegar extract, methylene chloride (MC) fraction, ethyl acetate (EtOAc) fraction or butanol (BuOH) fraction with a concentration of 0.7 g/ml was absorbed into a paper disc, and the filter paper (5×5 cm, 1.0 g) was placed on a petri dish. 30 sitophilus oryzae collected from the same group were placed on a petri dish (Φ=80 mm, h=10 mm), and cultured for 72 hours. The mortality number of sitophilus oryzae was then measured for five (5) times, and the average mortality number was obtained. The result of the measurement is listed in Table 6 and FIG. 6.

TABLE 6

| | Average mortality number of sitophilus oryzae | | | | | |
|---|---|---|---|---|---|---|
| hour | 3 | 6 | 9 | 12 | 24 | 48 |
| Oak vinegar | 11 | 16 | 17 | 12 | 22 | 24 |
| extract(Crude) | | | | | | |
| MC | 21 | 25 | 26 | 29 | 30 | 30 |
| EtOAc | 18 | 20 | 25 | 26 | 27 | 28 |
| BuOH | 9 | 10 | 13 | 14 | 15 | 18 |
| Ethanol(control | 0 | 0 | 0 | 0 | 0 | 0 |
| group) | | | | | | |

According to Table 6 and FIG. 6, after three (3) hours of adding the composition comprising the oak vinegar extract or fraction according to the present invention, as the average mortality number, 21 out of 30 sitophilus oryzae were killed by the addition of MC fraction, 18 killed by the addition of EtOAc fraction, 11 killed by the addition of oak vinegar extract, and 9 killed by the addtion of BuOH fraction. After 48 hours, a majority of sitophilus oryzae, i.e., 24˜30 were killed by the addition of MC fraction or EtOAc fraction.

Accordingly, it was confirmed that the oak vinegar extract or fraction according to the present invention provides superior insecticidal activity against sitophilus oryzae.

Accordingly, the composition comprising extract or fraction of oak vinegar as an effective ingredient has superior insect-repellent or insecticidal activities against sitophilus oryzae, which does severe damages to crops and has strong tolerance to insecticides, and therefore, can be applied efficaciously as an insect-repellent or insecticidal composition to conserve wooden furniture, an old house, or many organic cultural heritages.

1. A method for killing pests or insects inhabiting in an organic object, comprising treating the pests or insects with an effective dose of a composition comprising an extract of oak vinegar or an organic solvent fraction of oak vinegar.

2. (canceled)

3. The method of claim 1, wherein the organic solvent fraction comprises a methylene chloride (MC) fraction, an ethyl acetate (EtOAc) fraction, or a butanol (BuOH) fraction.

4. The method of claim 1, wherein the pests or insects comprise at least one of Lasioderma serricorne, Reticulitermes speratus kyushuensis Morimoto, and Sitophilus oryzae.

5. (canceled)

6. The method of claim 1, wherein treating the pests or insects comprises direct spraying, coating, fumigation, air freshing or wrapping the object.

7. (canceled)

8. The method of claim 1, wherein the object comprises an organic cultural heritage.

9. The method of claim 8, wherein the object comprises wood, paper, or textile heritage.

10. A method for resisting pests or insects inhabiting in an organic object, comprising treating the object with an effective dose of a composition comprising an extract of oak vinegar or an organic solvent fraction of oak vinegar.

11. The method of claim 10, wherein the pests or insects comprise at least one of Lasioderma serricorne, Reticulitermes speratus kyushuensis Morimoto, or Sitophilus oryzae.

12. The method of claim 10, wherein treating the object comprises direct spraying, coating, fumigation, air freshing, or wrapping the object.

13. The method of claim 10, wherein the object comprises an organic cultural heritage.

14. The method of claim 13, wherein the object comprises wood, paper, or textile heritage.

15. The method of claim 10, wherein the organic solvent fraction comprises a methylene chloride (MC) fraction, an ethyl acetate (EtOAc) fraction, or a butanol (BuOH) fraction.

16. A method of conserving an organic object, comprising treating the object with an effective dose of a composition comprising an extract of oak vinegar or an organic solvent fraction of oak vinegar.

17. The method of claim 16, wherein the pests or insects comprise at least one of Lasioderma serricorne, Reticulitermes speratus kyushuensis Morimoto, or Sitophilus oryzae.

18. The method of claim 16, wherein treating the object comprises direct spraying, coating, fumigation, air freshing, or wrapping the object.

19. The method of claim 16, wherein the object comprises an organic cultural heritage.

20. The method of claim 19, wherein the object comprises wood, paper, or textile heritage.

21. The of claim 16, wherein the organic solvent fraction comprises a methylene chloride (MC) fraction, an ethyl acetate (EtOAc) fraction, or a butanol (BuOH) fraction.
